(19) United States
(12) Patent Application Publication
(10) Pub. No.: US 2014/0208363 A1
(43) Pub. Date: Jul. 24, 2014

(54) SEARCHING METHOD AND DIGITAL STREAM SYSTEM

(71) Applicant: ALI (ZHUHAI) CORPORATION, Zhuhai (CN)

(72) Inventor: Xi-Liu Zeng, Zhuhai (CN)

(73) Assignee: ALI (ZHUHAI) CORPORATION, Zhuhai (CN)

(21) Appl. No.: 13/831,290

(22) Filed: Mar. 14, 2013

(30) Foreign Application Priority Data
Jan. 21, 2013 (CN) 201310021750.2

(51) Int. Cl. H04N 21/482

(52) U.S. Cl. CPC H04N 21/4828
USPC 725/53

(57) ABSTRACT

A searching method for a digital stream system, includes acquiring a plurality of selecting keywords related to a broadcast program from a network service terminal of the digital stream system according to a program consultation of the broadcast program; selecting at least one of the plurality of selecting keywords for assembling a searching keyword string; and acquiring a plurality of on-demand information from at least one on-demand resource service terminal according to the searching keyword string.

### BACKGROUND OF THE INVENTION

1. Field of the Invention

The present invention relates to a searching method and a digital stream system, and more particularly, to a searching method and a digital stream system capable of acquiring keywords from a network service terminal of the digital stream system for searching video stream related to a program consultation.

2. Description of the Prior Art

Home appliances are increasingly digitalized and integrated via a network. Via sufficient bandwidth of advanced network transmission technology, all kinds of home appliances (such as information, communication and consumer electronics) can be integrated. Television (TV) is arguably the most popular electronic product in the house; as such, how to digitalize TV is an important issue. The core product for digitalizing TV is the digital set-top box (STB), which is capable of decoding a digital TV broadcast signal. According to the different transmission method, the set-top box is classified into four categories: satellite set-top box, terrestrial set-top box, cable set-top box, and IP set-top box.

A digital set-top box acquires television programs via decoding the digital TV broadcast signal. Since the digital TV broadcast signal is a broadcast signal, the user can only watch a specific TV program at scheduled times of the specific TV program. If the TV program has finished playing or has already commenced, the user cannot watch the complete TV program. Moreover, if the TV program is a TV series, the user also cannot watch other episodes through the digital set-top box.

In the prior art, the user can search for information regarding the TV program (such as name of the producer, male lead and female lead) in a universal network resource via selecting program information in the electronic program guide. The user can select a single keyword from the acquired program information to perform a search in the universal network resource. As a result, the user can obtain figures related to the keyword. The user cannot, however, acquire and watch video streams related to the program information (ex. other episodes of the same TV series). Since the search is performed according to only a single keyword, the user cannot guarantee that precise search results will be acquired.

### SUMMARY OF THE INVENTION

Therefore, the present invention provides a searching method and a digital stream system capable of acquiring at least one keyword from the network service terminal for searching video streams related to the program consultation.

The present invention discloses a searching method for a digital stream system. The searching method comprises: acquiring a plurality of selecting keywords related to a broadcast program from a network service terminal of the digital stream system according to a program consultation of the broadcast program; selecting at least one of the plurality of selecting keywords for assembling a searching keyword string; and acquiring a plurality of on-demand information from at least one on-demand resource service terminal according to the searching keyword string.

The present invention further discloses a digital stream system. The digital stream system comprises: a network service terminal; a client terminal, for acquiring a plurality of selecting keywords related to a broadcast program from the network service terminal according to a program consultation of the broadcast program and selecting at least one of the plurality of selecting keywords to assemble a searching keyword string; and at least one on-demand resource service terminal, for outputting a plurality of on-demand information to the client terminal according to the searching keyword string.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a digital stream system according to an embodiment of the present invention.

FIG. 2 is a schematic diagram of another digital stream system according to an embodiment of the present invention.

FIG. 3 is a flow diagram of a searching method according to an embodiment of the present invention.

### DETAILED DESCRIPTION

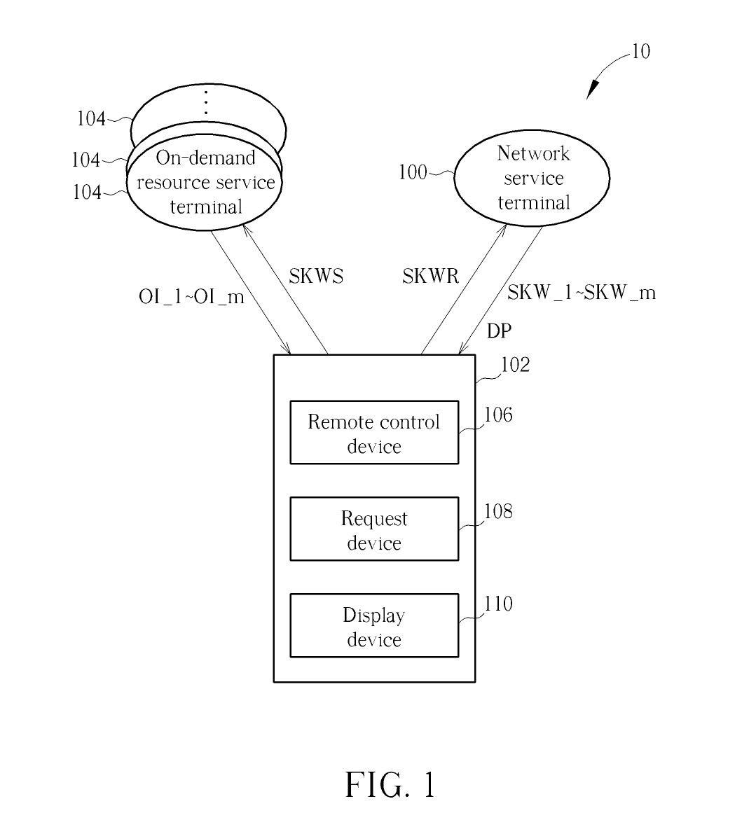

Please refer to FIG. 1, which is a schematic diagram of a digital stream system 10 according to an embodiment of the present invention. The digital stream system 10 is utilized for playing a digital stream. As shown in FIG. 1, the digital stream system 10 comprises a network service terminal 100, a client terminal 102 and a plurality of on-demand resource service terminals 104. The network service terminal 100 is utilized for providing digital stream content of a broadcast program DP to the client terminal 102. The client terminal 102 can be an electronic product with network function and display function, such as a smart TV or a conventional TV configured with a digital set-top box. The client terminal 102 comprises a remote control device 106, a request device 108 and a display device 110 and is utilized for transmitting a keyword request signal SKWR to the network service terminal 100 according to a program consultation of the broadcast program DP, to acquire selecting keywords SKW_{—}1-SKW_n related to the broadcast program DP. The client terminal 102 selects at least one of the selecting keywords SKW_{—}1-SKW_n to assemble a searching keyword string SKWS. According to the searching keyword string SKWS, the client terminal 102 can acquire on-demand information OI_{—}1-OI_m from the on-demand resource service terminals 104. In comparison with the prior art which searches keywords in the universal network, the client terminal 102 of the present invention acquires the selecting keywords SKW_{—}1-SKW_n precisely related to the broadcast program DP from the network service terminal 100. Furthermore, the prior art only uses a single keyword for searching figure information in the universal network. The client terminal 102 utilizes the searching keyword string SKWS comprising at least one of selecting keyword SKW_{—}1-SKW_n to search the on-demand information OI_{—}1-OI_m related to the broadcast program DP in the on-demand resource service terminals 104.

In detail, when the display device 110 of the client terminal 102 displays the program consultation (ex. the electronic program guide, EPG) related to the broadcast program DP, the user utilizes the remote control device 106 for generating a select signal SEL corresponding to the program consultation. The request device 108 transmits the keyword request signal SKWR to the network service terminal 100, to acquire selecting keywords SKW_{—}1-SKW_n related to the broadcast program DP. Since the selecting keywords SKW_{—}1-SKW_n are acquired from the network service terminal 100, the network broadcast suppliers can configure program information strongly related to the broadcast program DP in the selecting keywords SKW_{—}1-SKW_n. After acquiring the selecting keywords SKW_{—}1-SKW_n, the display device 110 displays the selecting keywords SKW_{—}1-SKW_n for allowing the user to select at least one of the selecting keywords SKW_{—}1-SKW_n, to generate the searching keyword string SKWS. According to the searching keyword string SKWS, the request device 108 can acquire the on-demand information OI_{—}1-OI_m related to the broadcast program DP from the on-demand resource service terminals 104 and make the display device 110 display the on-demand information OI_{—}1-OI_m. In this embodiment, the on-demand resource service terminals 104 are on-demand database (i.e. video websites) such as ‘youku’, ‘tudou’ and ‘youtube’. Finally, the user can watch the digital stream content related to the broadcast program DP on the on-demand resource service terminals 104 via selecting one of the on-demand information OI_{—}1-OI_m.

Please note that, since the client terminal 102 requests the selecting keywords SKW_{—}1-SKW_n from the network service terminal 100, the network broadcast supplier can configure selecting keywords SKW_{—}1-SKW_n precisely related to the broadcast program DP, to allow the user to assemble the searching keyword string SKWS strongly related to the broadcast program DP. The acquired on-demand information OI_{—}1-OI_m therefore fits the requirements of the user.

The following will describe detailed operation procedures of the digital stream system 10. When the user views the electronic program guide of the broadcast program DP through the display device 110, the user generates the select signal via the remote control device 106 to make the request device 108 to transmit the keyword request signal SKWR related to the broadcast program DP. According to the keyword request signal SKWR, the network service terminal 100 transmits the selecting keywords SKW_{—}1-SKW_n to the client terminal 102. The selecting keywords SKW_{—}1-SKW_n can be the program name, the producer, or the actors and the program type of the broadcast program DP. Based on the user preference, the user can randomly assemble the selecting keywords SKW_{—}1-SKW_n to generate the searching keyword string SKWS. Next, the request device 108 transmits the searching keyword string SKWS to at least one of the on-demand resource service terminals 104, for acquiring on-demand information OI_{—}1-OI_m related to the searching keyword string SKWS. Via selecting one of the on-demand information OI_{—}1-OI_m, the user can watch digital stream content related to the broadcast program DP from the on-demand resource service terminals 104 (ex. the follow-up episodes of the broadcast program DP).

The main spirit of the above embodiment is acquiring selecting keywords strongly related to the broadcast program from the network service terminal and acquiring the on-demand information according to the searching keyword string, which is assembled according to the user preference, from the on-demand resource service terminals, so as to provide convenient user experience. According to different applications, those skilled in the art may accordingly observe appropriate alternations and modifications. For example, the user can search on-demand information related to a broadcast program DP while watching the broadcast program via pressing a button of the remote control device 106. The user also can search on-demand information related to programs played at any time.

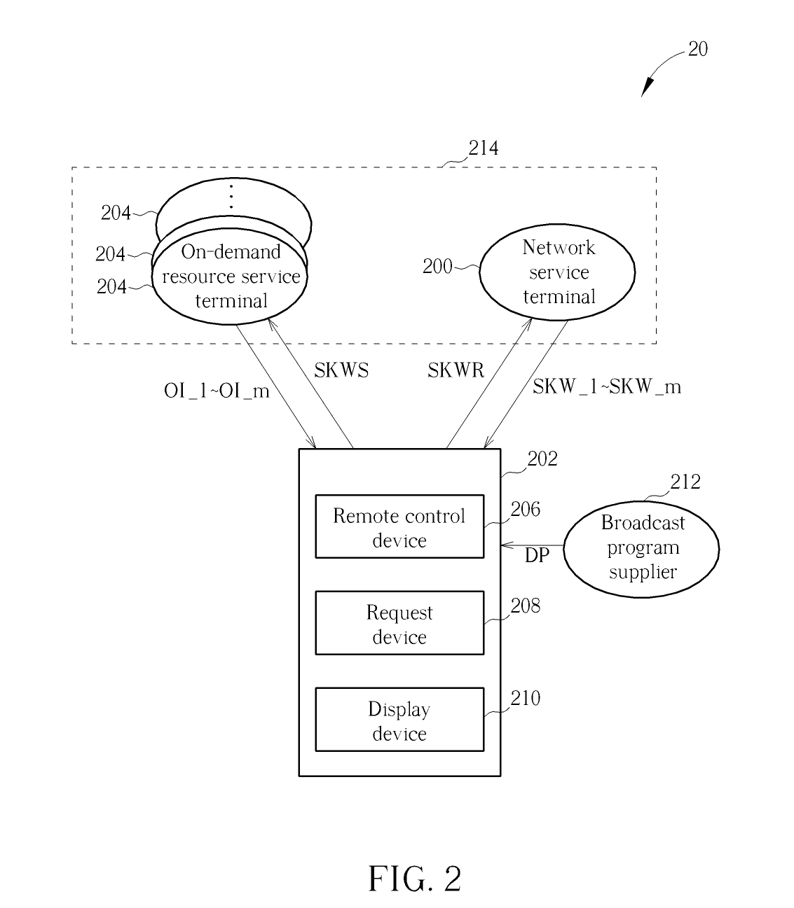

Please note that the broadcast program DP is provided by the network service terminal 100 in the digital stream system 10, but this is not limited herein. The supplier of the broadcast program DP and the owner of the network service terminal 100 can be different. Also, the network service terminal 100 and the on-demand resource service terminals 104 can be provided by the same supplier. Moreover, the network service terminal 100 and the on-demand resource service 104 can be realized in the same server. Please refer to FIG. 2, which is a schematic diagram of a digital stream system 20 according to an embodiment of the present invention. The digital stream system 20 is similar to the digital stream system 10, thus signals and devices with the same function use the same symbols. Different from the digital stream system 10, the broadcast program DP in the digital stream system 20 is provided by a broadcast program supplier 212 and the network service terminal 200 and the on-demand resource service terminal 212 is provided by a network on-demand supplier 214. The network service terminal and the on-demand resource service terminal 204 can be realized in the same server. While watching the broadcast program provided by the broadcast program supplier 212, the user can require selecting keywords SKW_{—}1-SKW_n related to the broadcast program DP from the network service terminal 200 of the network on-demand supplier 214 according to the electronic program guide of the broadcast program DP (provided by the broadcast program supplier 212). Then, the user can accordingly acquire on-demand program video stream from the on-demand resource service terminal 204 of the network on-demand supplier 214.

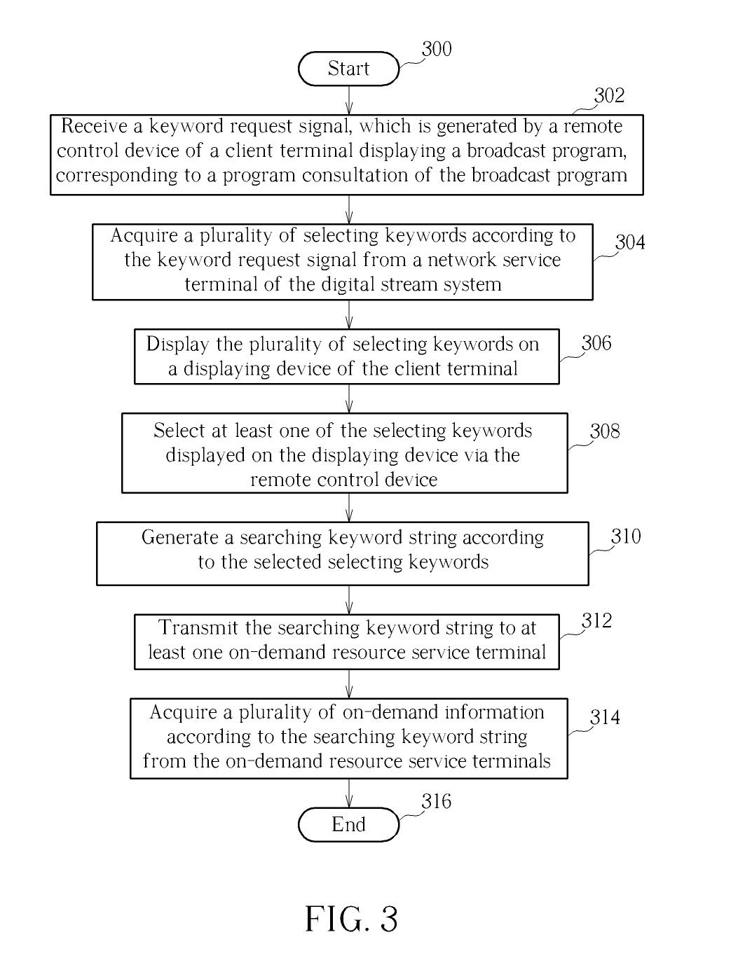

The procedures of the digital stream system 10 searching the related on-demand information on the on-demand resource service terminal 104 according to the program consultation of the broadcast program DP can be summarized into a searching method 30. Please refer to FIG. 3 for an illustration of this the searching method 30 comprises:

Step 300: Start.

Step 302: Receive a keyword request signal, which is generated by a remote control device of a client terminal displaying a broadcast program, corresponding to a program consultation of the broadcast program.

Step 304: Acquire a plurality of selecting keywords according to the keyword request signal from a network service terminal of the digital stream system.

Step 306: Display the plurality of selecting keywords on a displaying device of the client terminal.

Step 308: Select at least one of the selecting keywords displayed on the displaying device via the remote control device.

Step 310: Generate a searching keyword string according to the selected selecting keywords.

Step 312: Transmit the searching keyword string to at least one on-demand resource service terminal.

Step 314: Acquire a plurality of on-demand information according to the searching keyword string from the on-demand resource service terminals.

Step 316: End.

According to the searching method 30, the digital stream system can acquire the plurality of selecting keywords related to the broadcast program. Via selecting at least one of the selecting keywords, the digital stream system can acquire the searching keyword string. The digital stream system can accordingly acquire the plurality of on-demand information, so as to play digital stream content related to the broadcast program. The detailed operations of the searching method 30 can be known by referring to the above, and are not narrated herein for brevity.

To sump up, the searching method and the digital stream system disclosed in the above embodiments can acquire selecting keywords precisely related to the broadcast program from the network service terminal. According to the searching keyword string comprising at least one selecting keyword, the searching method and the digital stream system disclosed in the above embodiments searches the on-demand information related to the broadcast program on the on-demand resource service terminal, so as to allow the user to watch video streams related to the broadcast program.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A searching method for a digital stream system, comprising:
acquiring a plurality of selecting keywords related to a broadcast program from a network service terminal of the digital stream system according to a program consultation of the broadcast program;
selecting at least one of the plurality of selecting keywords for assembling a searching keyword string; and
acquiring a plurality of on-demand information from at least one on-demand resource service terminal according to the searching keyword string.

2. The searching method of claim 1, wherein the program consultation is an electronic program guide.

3. The searching method of claim 1, wherein the on-demand resource service terminal is a video website.

4. The searching method of claim 1 further comprising:
selecting one of the plurality of on-demand information as a playing information; and
acquiring digital stream content from the on-demand resource service terminal according to the playing information.

5. The searching method of claim 1, wherein the step of acquiring the plurality of selecting keywords related to the broadcast program from the network service terminal of the digital stream system according to the program consultation of the broadcast program comprises:
receiving a keyword request signal corresponding to the program consultation from a client terminal which broadcasts the broadcast program, wherein the keyword request signal is generated by a remote control device of the client terminal;
requesting the plurality of selecting keywords from the network service terminal of the digital stream system according to the keyword request signal; and
displaying the plurality of selecting keywords on the client terminal.

6. The searching method of claim 1, wherein the step of selecting at least one of the plurality of selecting keywords for assembling the searching keyword string comprises:
selecting at least one of the plurality of selecting keywords displayed on the client terminal by the remote control device;
generating the searching keyword string according to the selected selecting keywords; and
transmitting the searching keyword string to the on-demand resource service terminal.

7. A digital stream system, comprising:
a network service terminal;
a client terminal, for acquiring a plurality of selecting keywords related to a broadcast program from the network service terminal according to a program consultation of the broadcast program and selecting at least one of the plurality of selecting keywords to assemble a searching keyword string; and
at least one on-demand resource service terminal, for outputting a plurality of on-demand information to the client terminal according to the searching keyword string.

8. The digital stream system of claim 7, wherein the program consultation is an electronic program guide.

9. The digital stream system of claim 7, wherein the on-demand resource service terminal is a video website.

10. The digital stream system of claim 7, wherein the client terminal further selects one of the plurality of on-demand information as a playing information and acquires digital stream content from the on-demand resource service terminal according to the playing information.

11. The digital stream system of claim 7, wherein the client terminal comprises:
a remote control device, for generating a request signal corresponding to the program consultation of the broadcast program;
a request device, for requesting the plurality of selecting keywords from the network service end according to the request signal; and
a display device, for displaying the plurality of selecting keywords.

12. The digital stream system of claim 11, wherein the remote control device is further utilized for selecting at least one of the plurality of selecting keywords to generate the searching keyword string and the request device is further utilized for transmitting the searching keyword string to the on-demand resource service terminal.
